(19) United States
(12) Patent Application Publication
(10) Pub. No.: US 2008/0213581 A1
(43) Pub. Date: Sep. 4, 2008

(54) INPUT DEVICE FOR A MAN-MACHINE INTERFACE

(76) Inventor: Chih-Cheng Chen, Yung Kang (TW)

Correspondence Address: G. LINK CO., LTD., 3550 BELL ROAD, MINOOKA, IL, 60447, US

(21) Appl. No.: 11/968,167

(22) Filed: Jan. 1, 2008

(30) Foreign Application Priority Data
Jan. 17, 2007 (TW) 096101690

(51) Int. Cl. B32B 7/12

(52) U.S. Cl. 428/354

(57) ABSTRACT

An input device for a man-machine interface includes an upper board and a lower board. Each of the boards provides a plastic based resistant film structure or a glass based resistant film structure. The resistant film structure is formed with a printed silver conductor layer being printed on the surface of an ITO based or an ITO glass based conductive film, a carbon layer being overlaid the printed silver conductor layer, an insulation layer being overlaid the carbon layer and an adhesive layer being overlaid the insulation layer. The carbon layer is capable of preventing the silver conductor layer from phenomenon of dissociation resulting from the variable temperature and humidity such that steadiness and reliability of the input device can be secured and life span and durability of the input device can be enhanced.

### BACKGROUND OF THE INVENTION

1. Field of the Invention

The present invention is related to an input device for a man-machine interface and particularly to a specific structure on the upper plate and the lower plate of the input device for enhancing reliability, steadiness and life span.

2. Brief Description of the Related Art

The conventional touch pad can be classified into the following types: the resistance type touch pad, the capacitance type touch pad, the inductance touch pad, the infrared type touch pad, and the supersonic touch pad. The resistance type touch pad is the most popular type due to cheaper price. The resistance type touch pad as shown in FIG. 1 consists of an upper board 10 and a lower board 20. The upper board 10 as shown in FIGS. 2 provides a structure sequentially formed with an indium tin oxide based conductive film 31, a silver conductor layer 32, an insulation layer 34 and an adhesive layer 35. The lower board 20 as shown in FIGS. 3 provides a structure sequentially formed with an indium tin oxide glass based conductive film 41, a silver conductor layer 42, an insulation layer 44 and an adhesive layer 45.

A process of silver printing has to be performed in order to fabricate the silver conductor layer. However, the printed silver conductor is apt to result in dissociation of silver ions in an environment with variable temperature and humidity and it is unfavorable for reliability of the touch pad. Consequently, steadiness and life span of the touch pad are seriously affected and quality of the touch pad is influenced significantly.

### SUMMARY OF THE INVENTION

In order to overcome the deficiencies of the preceding prior art, an object of the present invention is to provide an input device for a man-machine interface in which a carbon layer is provided to stabilize the touch pad and prolong the life span of the touch pad.

Another object of the present invention is to provide an input device for a man-machine interface with which the reliability of the touch pad can be enhanced even in an environment with a variable temperature and severe humidity.

Accordingly, an input device for a man-machine interface according to the present invention comprises an upper board, which provides a first plastic based resistant film structure, and a lower board, which is corresponding to the upper board and provides a second plastic based resistant film structure; wherein, the first and second plastic based resistant film structures are respectively composed of an ITO based conductive film, a printed silver conductor layer, a carbon layer, an insulation layer and a adhesive layer sequentially.

Further, an input device for a man-machine interface comprises an upper board, which provides a first glass based resistant film structure, and a lower board, which is corresponding to the upper board and provides a second glass based resistant film structure opposite to said first glass based resistant film structure; wherein, the first and second glass based resistant film structures are respectively composed of an ITO glass based conductive film, a printed silver conductor layer, a carbon layer, an insulation layer and a adhesive layer, sequentially.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a plan view of the conventional resistance type touch pad;

FIG. 2 is a fragmentary sectional view illustrating the structure of the upper board of the conventional resistance type touch pad shown in FIG. 1;

FIG. 3 is a fragmentary sectional view illustrating the structure of the lower board of the conventional resistance type touch pad shown in FIG. 1;

FIG. 4 is a perspective view illustrating the structure of the resistance type touch pad of an input device for a man-machine interface according to the present invention;

FIG. 5 is a fragmentary sectional view illustrating an embodiment of a structure on the upper board and the lower board of the touch pad shown in FIG. 4 respectively;

FIG. 6 is a fragmentary sectional view illustrating another embodiment of a structure on the upper board and the lower board of the touch pad shown in FIG. 4 respectively;

FIG. 7 is a fragmentary sectional view illustrating a further embodiment of a structure on the upper board and the lower board of the touch pad shown in FIG. 4 respectively;

FIG. 8 is a fragmentary sectional view illustrating a further embodiment of a structure on the upper board and the lower board of the touch pad shown in FIG. 4 respectively;

FIG. 9 is a plan view of an embodiment of an input device for a man-machine interface according to according to the present invention;

FIG. 10 is a plan view of another embodiment of an input device for a man-machine interface according to according to the present invention; and

FIG. 11 is a plan view of a further embodiment of an input device for a man-machine interface according to according to the present invention.

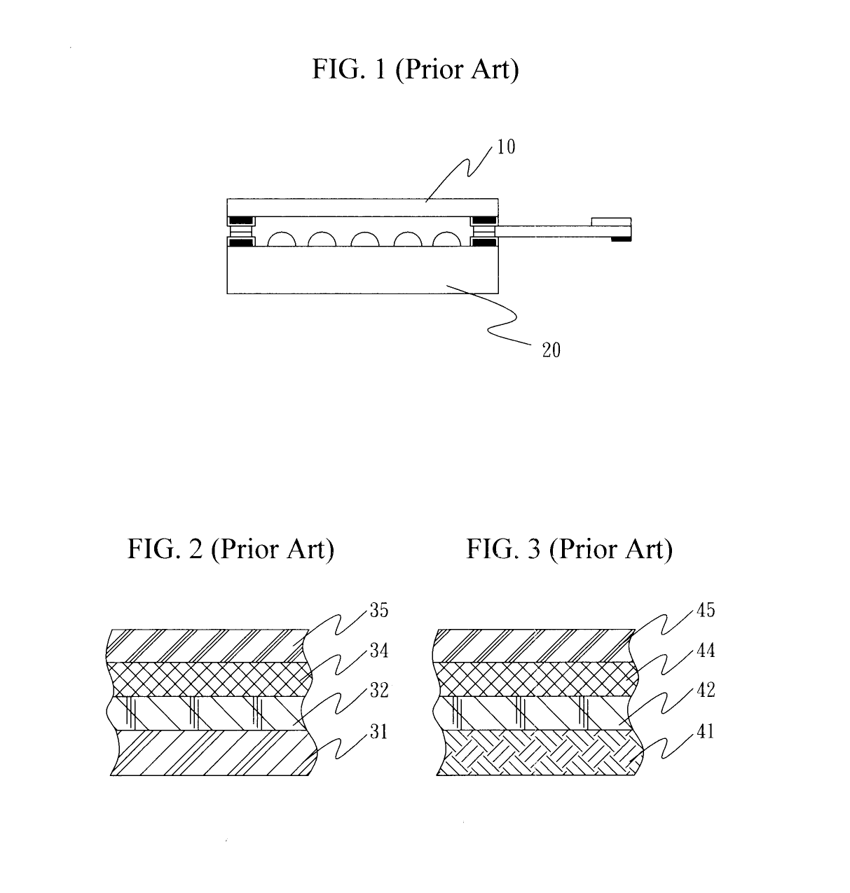

### DETAILED DESCRIPTION OF THE INVENTION

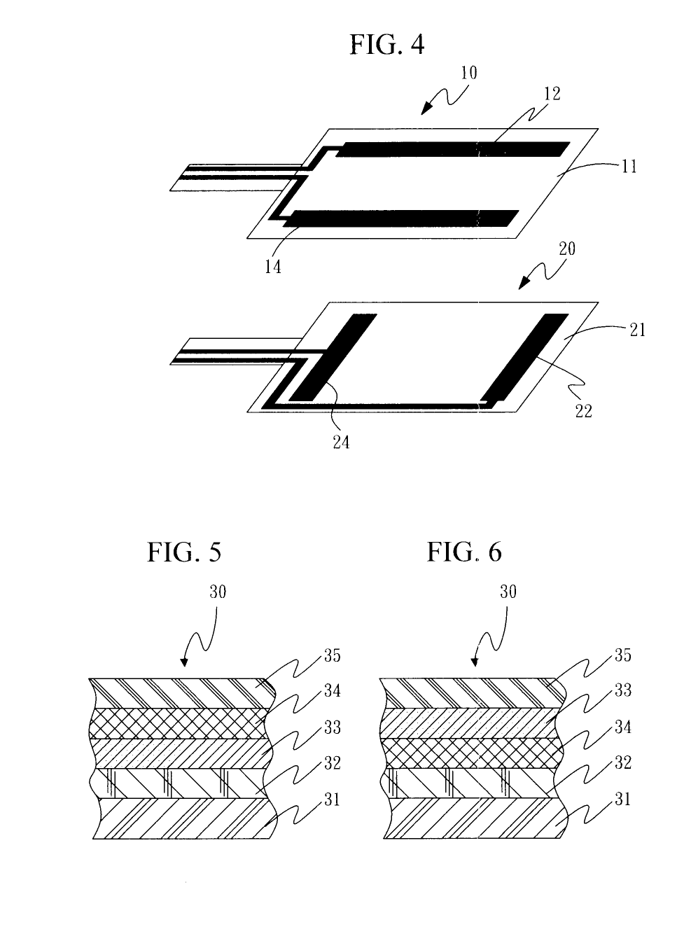

Referring to FIG. 4, the resistance type touch pad of an input device for a man-machine interface according to the present invention includes an upper board 10 and a lower board 20. The upper board 10 basically provides a layer of upper conductive film 11 made of Indium Tin Oxide (ITO) and a pair of upper electrodes 12, 14, which are printed silver conductors, are provided on the upper conductive film 11 and disposed next to two opposite lateral sides of the upper conductive film 11 respectively. One of the upper electrodes 12. 14 is an upper positive electrode 12 and the other one of the upper electrodes 12, 14 is an upper negative electrode 14. The lower board 20 provides a layer of lower conductive film 21 made of Indium Tin Oxide (ITO) and a pair of lower electrodes 12, 14, which are printed silver conductors, are provided on the lower conductive film 21 and disposed next to two opposite lateral sides of the lower conductive film 21 respectively. One of the lower electrodes 12, 14 is a lower positive electrode 12 and the other one of the lower electrodes 12, 14 is a lower negative electrode 14. It is noted that the upper positive and negative electrodes 12, 14 are arranged in parallel and perpendicular to the lower positive and negative electrodes 22, 24, which are arranged in parallel too. When the two ITO conductive films 11, 21 are point-pressed at any spot thereon respectively at the time of the upper positive electrodes 12, 22 being electrified, the corresponding voltages induced can be determined via the negative electrodes 14, 24. Hence, the corresponding X coordinate and Y coordinate at the pressed spot can be figured out by the microprocessor after the corresponding voltages passing through the analog/digital converter. This is the principle of the resistance type touch pad.

Referring to FIG. 5, a detail structure of an embodiment of the upper and the lower boards 10, 20 according to the present invention is illustrated. A plastic based resistant film structure 30 is composed of an ITO conductive based film 31, a printed silver conductor layer 32, a carbon film layer 33, an insulation layer 34 and an adhesive layer 35. The ITO based conductive film 31 is printed with silver conductor lay 32. Then, a carbon layer 33, an insulation layer 34 and an adhesive layer 35 are coated sequentially on the printed silver conductor layer 32 as shown in FIG. 5. That is, the printed silver conductor layer 32 is on top of the ITO based conductive film 31, the carbon layer 33 is on top of the printed silver conductor layer 32, the insulation layer 34 is on top of the carbon layer 33, and the adhesive layer 35 is on top of the insulation layer 34. A detail structure of another embodiment of the upper board 10 and the lower board 20 according to the present invention is illustrated in FIG. 6. A plastic based resistant film structure 30 is composed of an ITO based conductive film 31, a printed silver conductor layer 32, a carbon layer 33, an insulation layer 34 and an adhesive layer 35 too. The difference of the ITO resistant film structure 30 shown in FIG. 6 from that shown in FIG. 5 is in that the insulation layer 34 is on top of the printed silver conductor layer 32 and the carbon layer 33 is on top of the insulation layer 34 instead.

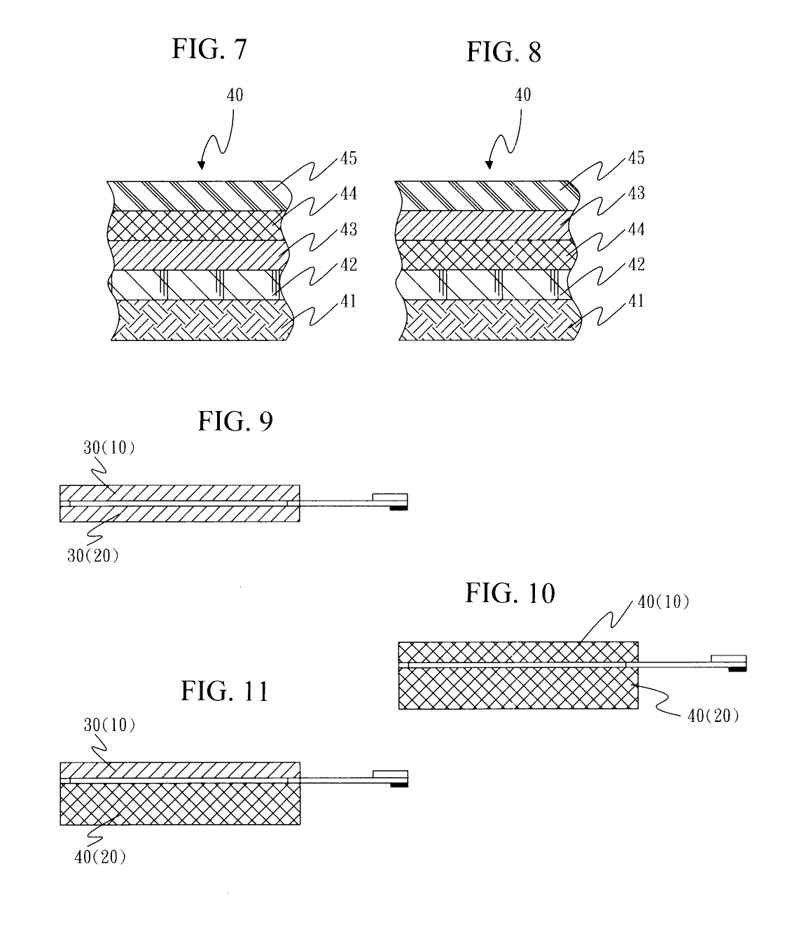

Referring to FIG. 7, a detail structure of a further embodiment of the upper and lower boards 10, 20 according to the present invention is illustrated. An ITO glass resistant film structure 40 is composed of an ITO glass based conductive film 41, a printed silver conductor layer 42, a carbon layer 43, an insulation layer 44 and an adhesive layer 45. The ITO glass based conductive film 41 is overlaid with the printed silver conductor layer 42. Then, the carbon layer 43, the insulation layer 44 and the adhesive layer 45 are coated sequentially on the printed silver conductor layer 32. That is, the printed silver conductor layer 42 is on top of the ITO glass based conductive film 41, the carbon layer 43 is on top of the printed silver conductor layer 42, the insulation layer 44 is on top of the carbon layer 43, and the adhesive layer 45 is on top of the insulation layer 44. A detail structure of a further embodiment of the upper and the lower boards 10. 20 according to the present invention is illustrated in FIG. 8. The glass based resistant film structure 40 shown in FIG. 8 is composed of an ITO glass based conductive film base 41, a printed silver conductor layer 42, a carbon layer 43, an insulation layer 44 and an adhesive layer 45 too. The difference of the structure of the glass resistant film structure 40 shown in FIG. 8 from that shown in FIG. 7 is in that the insulation layer 44 is on top of the printed silver conductor layer 42 and the carbon layer 43 is on top of the insulation layer 44 instead.

As the foregoing, when both the upper and lower boards 10, 20 of the resistance type touch pad of an input device for a man-machine interface according to the present invention provide the plastic based resistant film structure 30 as shown in FIGS. 5 and 6, the touch pad is illustrated in FIG. 9. When both the upper and lower boards 10, 20 of the resistance type touch pad of an input device for a man-machine interface according to the present invention provide the glass based resistant film structure 40 as shown in FIGS. 7 and 8, the touch pad is illustrated in FIG. 10.

Alternatively, the plastic based resistant film structure 30 and the glass based resistant film structure 40 can be provided at one of the upper and lower boards 10, 20 instead of both the same plastic based resistant film structure 30 or both the same glass based resistant film structure 40 being at the upper and lower boards 10, 20 respectively. FIG. 11 shows the plastic based resistant film structure 30 is provided at the upper board 10 and the glass based resistant film structure 40 is provided at the lower board 20. Of course, the plastic based resistant film structure 30 can be provided at the lower board 20 and the glass based resistant film structure 40 provided at the upper board 10 instead.

It is worth to mention that the carbon film layer, which is arranged in the plastic based resistant film structure 30 and the glass based resistant film structure 40, is capable of significantly stabilizing the electrons and restricting the phenomenon of the silver ions being possibly dissociated from the conductor layer resulting from the variable temperature and humidity. Hence, it enhances steadiness and life span of the touch pad and reliability of the touch pad against the temperature and the humidity.

While the invention has been described with referencing to the preferred embodiments thereof, it is to be understood that modifications or variations may be easily made without departing from the spirit of this invention, which is defined by the appended claims.

What is claimed is:

1. An input device for a man-machine interface comprising:
an upper board providing a first plastic based resistant film structure; and
a lower board corresponding to said upper board and providing a second plastic based resistant film structure opposite to said first plastic based resistant film structure;
wherein, said first and second plastic based resistant film structures are respectively composed of an ITO based conductive film, a printed silver conductor layer, a carbon layer, an insulation layer and a adhesive layer.

2. The input device for a man-machine interface as defined in claim 1, wherein said first plastic based resistant film structure is formed with said printed silver conductor layer being printed on the surface of said ITO based conductive film, said carbon layer being overlaid said printed silver conductor layer, said insulation layer being overlaid said carbon layer and said adhesive layer being overlaid said insulation layer.

3. The input device for a man-machine interface as defined in claim 1, wherein said second plastic based resistant film structure is formed with said printed silver conductor layer being printed on the surface of said ITO based conductive film, said carbon layer being overlaid said printed silver conductor layer, said insulation layer being overlaid said carbon layer and said adhesive layer being overlaid said insulation layer.

4. The input device for a man-machine interface as defined in claim 1, wherein said first plastic based resistant film structure is formed with said printed silver conductor layer being printed on the surface of said ITO based conductive film, said insulation layer being overlaid said printed silver conductor layer, said carbon layer being overlaid said insulation layer and said adhesive layer being overlaid said carbon layer.

5. The input device for a man-machine interface as defined in claim 1, wherein said second plastic based resistant film structure is formed with said printed silver conductor layer being printed on the surface of said ITO based conductive film, said insulation layer being overlaid said printed silver conductor layer, said carbon layer being overlaid said insulation layer and said adhesive layer being overlaid said carbon layer.

6. An input device for a man-machine interface comprising:
an upper board providing a first glass based resistant film structure; and
a lower board corresponding to said upper plate and providing a second glass based resistant film structure opposite to said first glass based resistant film structure;
wherein, said first and second glass based resistant film structures are respectively composed of an ITO glass based conductive film, a printed silver conductor layer, a carbon layer, an insulation layer and a adhesive layer.

7. The input device for a man-machine interface as defined in claim 6, wherein said first glass based resistant film structure is formed with said printed silver conductor layer being printed on the surface of said ITO glass based conductive film, said carbon layer being overlaid said printed silver conductor layer, said insulation layer being overlaid said carbon layer and said adhesive layer being overlaid said insulation layer.

8. The input device for a man-machine interface as defined in claim 6., wherein said second glass based resistant film structure is formed with said printed silver conductor layer being printed on the surface of said ITO glass based conductive film, said carbon layer being overlaid said printed silver conductor layer, said insulation layer being overlaid said carbon layer and said adhesive layer being overlaid said insulation layer.

9. The input device for a man-machine interface as defined in claim 6, wherein said first glass based resistant film structure is formed with said printed silver conductor layer being printed on the surface of said ITO glass based conductive film, said insulation layer being overlaid said printed silver conductor layer, said carbon layer being overlaid said insulation layer and said adhesive layer being overlaid said carbon layer.

10. The input device for a man-machine interface as defined in claim 6, wherein said second glass based resistant film structure is formed with said printed silver conductor layer being printed on the surface of said ITO glass based conductive film, said insulation layer being overlaid said printed silver conductor layer, said carbon layer being overlaid said insulation layer and said adhesive layer being overlaid said carbon layer.
